(19) United States
(12) Patent Application Publication
(10) Pub. No.: US 2025/0062926 A1
(43) Pub. Date: Feb. 20, 2025

(54) APPARATUS AND METHOD TO SET UP A MULTIROOM MEETING

(71) Applicant: CANON U.S.A., INC., Melville, NY (US)

(72) Inventor: Shingo Murata, Mineola, NY (US)

(21) Appl. No.: 18/807,138

(22) Filed: Aug. 16, 2024

Related U.S. Application Data
(60) Provisional application No. 63/520,475, filed on Aug. 18, 2023.

(51) Int. Cl. H04L 12/18; G06V 40/20; H04L 65/1093

(52) U.S. Cl. CPC H04L 12/1822; G06V 40/20; H04L 65/1093

(57) ABSTRACT

A system for starting multi online meeting having a client, a server, a first meeting control apparatus associated with a first room, and a second meeting control apparatus associated with a second room. The client requests, to the server, to add another meeting control apparatus to the online meeting which the first meeting control apparatus joins. The server provides access information to the second meeting control apparatus to the client in response to the request from the client. The accesses the second meeting control apparatus based on the access information provided by the server and send the meeting ID to the second meeting control apparatus so that the second meeting control apparatus can join the online meeting. The second meeting control performs a verification process to check if a person is in the second room or not. The second meeting control apparatus joins the online meeting and sends an image captured by an image capture apparatus in the second room to the server after the verification process is passed.

### CROSS REFERENCE TO RELATED APPLICATIONS

This application claims priority from U.S. Provisional Patent Application Ser. No. 63/520,475 filed on Aug. 18, 2023, the entirety of the application is incorporated herein by reference.

### FIELD

The present disclosure relates to online meeting applications and, more specifically, a mechanism for establishing a meeting between more than one meeting room.

### DESCRIPTION OF RELATED ART

Online meetings between users is known including when a group of individuals at one location are communicating remotely with one or more individuals not presently located at the one location. In the case of an online meeting between individuals at an office in a particular meeting room and remote users (e.g. users at home), a camera is provided at the particular meeting room so that the remote users can see the individuals and objects in the particular meeting room. After starting the online meeting, meeting attendees sometimes encounter the situation that they would like to add another room, where another camera is provided, to the existing online meeting.

### SUMMARY

A system, a method, and an apparatus according to the present disclosure remedies the drawbacks associated with current online meeting solutions to improve usability in a case where the meeting attendees would like to add another room, where another camera is provided, to the existing online meeting.

According to an aspect of the disclosure, a system for starting multi online meeting is provided. the system includes a client, a server, a first meeting control apparatus associated with a first room, and a second meeting control apparatus associated with a second room. The client is configured to request to the server to add another meeting control apparatus to the online meeting which the first meeting control apparatus joins. The server is configured to provide access information to the second meeting control apparatus to the client in response to the request from the client. The client is configured to access to the second meeting control apparatus based on the access information provided by the server. The client is configured to send the meeting ID to the second meeting control apparatus so that the second meeting control apparatus can join the online meeting. The second meeting control apparatus is configured to perform a verification process to check if a person is in the second room or not. The second meeting control apparatus is configured to join the online meeting and send an image captured by an image capture apparatus in the second room to the server after the verification process is passed.

### BRIEF DESCRIPTION OF THE DRAWINGS

FIG. 1 is a drawing illustrating a system architecture.

FIG. 2 is a block diagram illustrating a hardware architecture.

FIG. 3 is an flow diagram detailing the processing steps associated with setting up multiple rooms for an online meeting.

FIG. 4A is an example of a meeting screen.

FIG. 4B is an example of a selection screen.

FIG. 4C is an example of a verification screen.

FIG. 4D is an example of a meeting screen after the multi online meeting has started.

FIG. 4E is another example of a verification screen.

FIG. 4F is an example of a screen showing a verification code.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. The following exemplary embodiments are merely examples for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

### <System Architecture>

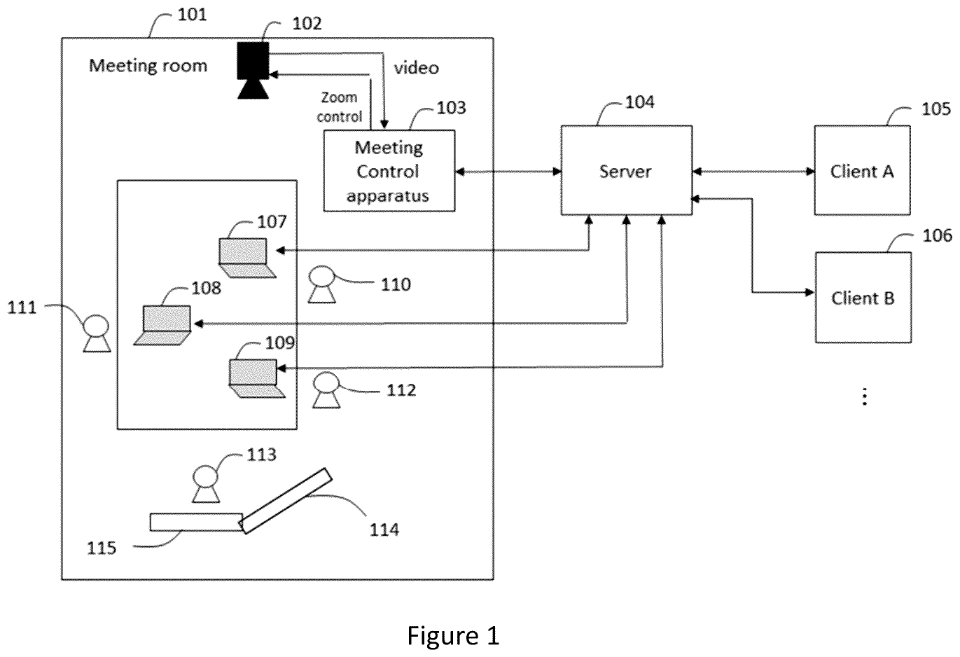

FIG. 1 illustrates a system architecture according to an exemplary embodiment. The system includes an image capture apparatus (a camera) 102, a meeting control apparatus 103, a server 104, a client computer A 105, a client computer B 106 and communication apparatuses 107-109. The communication apparatuses 107-109 can be a laptop computer, a tablet computer, a smartphone or other type of computer and are operated by respective attendees 110-112.

As illustrated in FIG. 1, the client computer A 105 and the client computer B 106 connect to, via a communication network, an online meeting held in the meeting room 101. In the present embodiment, the image capture apparatus 102, the meeting control apparatus 103, the communication apparatuses 107-109, the attendees 110-112, a presenter 113 and white boards 114-115 can be present in the meeting room 101, but this is not seen to be limiting. In another exemplary embodiment, for example, the functionality provided by the meeting control apparatus 103 as described below can be located in the cloud.

The meeting control apparatus 103 includes all the local modules, such as gesture recognition module, image capturing apparatus control module (pan/tilt/zoom), and meeting state management module. The server 104 manages meeting resources, and communication/synchronization between clients and modules included in the meeting control apparatus 103.

The image capture apparatus 102 captures video in the meeting room 101 while a meeting is in progress. The image capture apparatus 102 captures gestures by the attendees 110-112 and the presenter 113. The captured video is transmitted to the meeting control apparatus 103. As described above, the meeting control apparatus 103 can recognize user's gesture included in the video, and execute the process corresponding to the gesture.

Once the online meeting starts, the client computer A 105 and the client computer B 106 can display the video captured by the image capture apparatus 102 so that remote attendees can view what is going on in the meeting room 101, including anything that may be written on the white boards 114-115. The communication apparatuses 107-109 can display the same video so that attendees 110-112 are able to view what the remote attendees are viewing.

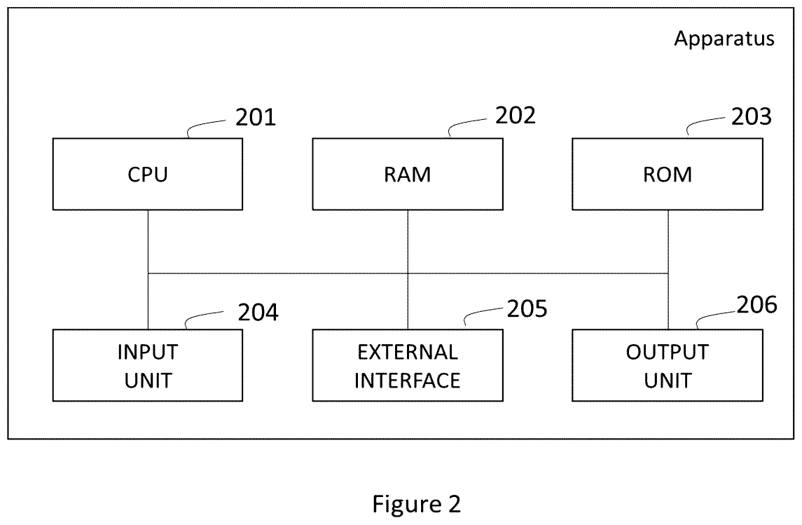

FIG. 2 illustrates a hardware architecture according to an exemplary embodiment that represents the hardware architecture of the image capture apparatus 102, the meeting control apparatus 103, the server 104 and the communication apparatuses 107-109. The hardware architecture includes a CPU 201, a RAM 202, a ROM 203, an input unit 204, an external interface 205, and an output unit 206. For description purposes, the meeting control apparatus 103 will be referred to/used to describe the various components illustrated in FIG. 2.

The CPU 201 controls the meeting control apparatus 103 via a computer program (one or more series of stored instructions executable by the CPU 201) and data stored in the RAM 202 or ROM 203. The meeting control apparatus 103 can include one or more dedicated hardware or a graphics processing unit (GPU), which is different from the CPU 201, and the GPU or the dedicated hardware can perform a part of the processes by the CPU 201. As an example of the dedicated hardware, there are an application specific integrated circuit (ASIC), a field-programmable gate array (FPGA), and a digital signal processor (DSP), and the like.

The RAM 202 temporarily stores the computer program or data read from the ROM 203, data supplied external from the meeting control apparatus 103 via the external interface 205, and the like. The ROM 203 stores the computer program and data that do not need to be modified and that can control the basic operation of the meeting control apparatus 103.

The input unit 204 is composed of, for example, a joystick, a jog dial, a touch panel, a keyboard, a mouse, or the like, receives a user operation, and inputs various instructions to the CPU 201. The external interface 205 communicates with external device such as PC, smartphone, camera and the like. The communication with the external devices can be performed via a wired interface such as a local area network (LAN) cable, a serial digital interface (SDI) cable or can performed wirelessly via a wireless interface such as Wi-Fi®, etc., The output unit 206 is composed of, for example, a display unit and a sound output unit such as a speaker, and displays a graphical user interface (GUI) and outputs a guiding sound so that the user can operate the meeting control apparatus 103 as needed.

### <Multi-Room Setup>

In the exemplary embodiment, a plurality of online meeting can be combined. That is, the video captured by the image capture apparatus 102 in Room A and the video captured by the image capture apparatus 102 in Room B can be shown in the same screen. This function is called as “Multi-room setup”.

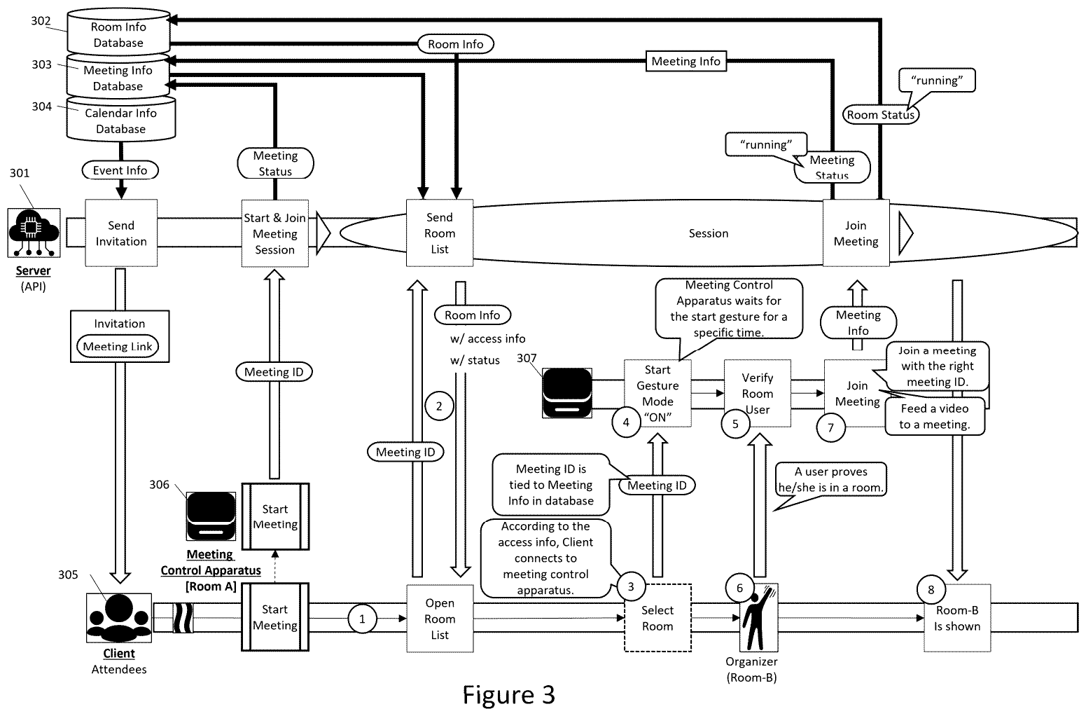

FIG. 3 illustrates an overall flow of “Multi-room setup”. A server 301 includes Room Info Database 302, Meeting Info Database 303, and Calendar Info Database 304. Room Info Database 302 stores “Room Info” which includes “Room List” and “Room Status”. “Room List” is a list of meeting rooms equipped with the system illustrated in FIG. 1. “Room Status” is status information which shows if the meeting room is used or not. Meeting Info Database 303 stores “Meeting Info” which includes “Meeting Link”, “Meeting ID” and “Meeting Status”. “Meeting Link” is an URL to connect to an online meeting. “Meeting ID” is a number or character assigned to an online meeting to distinguish it from others. “Meeting Status” is status information which shows if an online meeting is running or not. Calendar Info Database 304 stores “Event Info” which shows when and where an online meeting will be held. “Event Info” also shows attendees of an online meeting. “Event Info” is tied to “Meeting Link”.

The server 301 corresponds to the server 104 in FIG. 1. client 305 corresponds to one of the client computer A 105, the client computer B 106, and the communication apparatuses 107-109 for attendees in FIG. 1. First meeting control apparatus 306 and second meeting control apparatus 307 correspond to the meeting control apparatus 103 in FIG. 1. The first meeting control apparatus 306 corresponds to Room A and the second meeting control apparatus 307 corresponds to Room B. Room A and Room B are different meeting rooms.

The details of each step will be explained as follows. An index number for each process corresponds to an index number in FIG. 3.

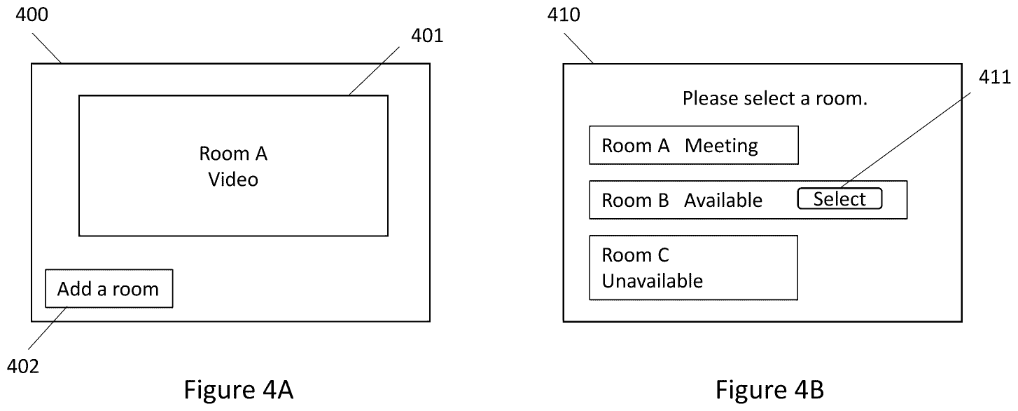

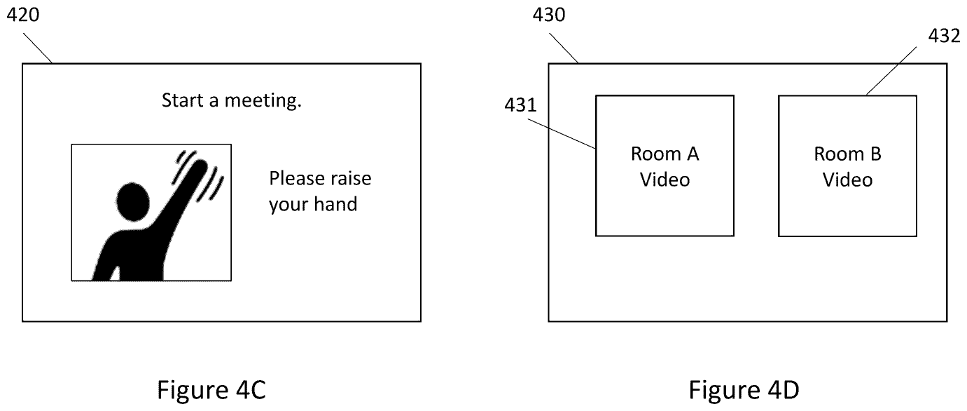

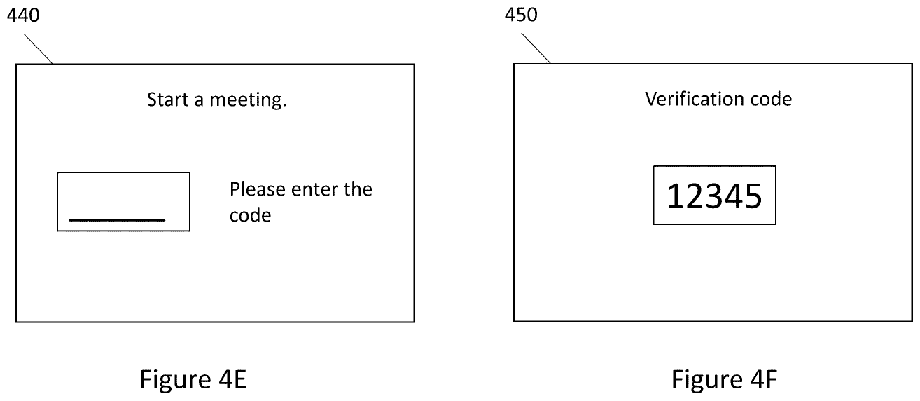

An online meeting associated with Room A has already started. The client 305 and The first meeting control apparatus 306 are joining the online meeting. FIG. 4A illustrates an example of a meeting screen 400. client 305 shows the meeting screen 400 on a display while the online meeting is in session. The video captured by the image capture apparatus 102 in Room A is displayed in a video screen 401, and there is a “Add a room” button 402 in the meeting screen 400. A user can click the “Add a Room” button 402 to set up multi online meeting.

When clicking the “Add a Room” button 402, client 305 sends “Meeting ID” of the online meeting associated with Room A to the server 301. In response to that, the server 301 sends “Room Info” to the client 305. The server 301 obtains “Room Info” from Room Info Database 302. “Room Info” includes “Room List”, access information (IP address) to each meeting control apparatus, and status information of each meeting control apparatus.

FIG. 4B illustrates an example of a selection screen 410. The client 305 shows the selection screen 410 on the display. The selection screen 410 shows if a room is available or not based on the status information. The user can select a room (corresponding meeting control apparatus) to be added to the online meeting.

By selecting the room, the client 305 accesses to the second meeting control apparatus 307 corresponding to the selected room (e.g. Room B) based on the access information provided by the server 301. The client 305 sends “Meeting ID” to the second meeting control apparatus 307 corresponding to the selected room.

To set up multi online meeting, the second meeting control apparatus 307 needs to verify if someone is in the meeting room. This is to ensure security and confidentiality in the meeting room. FIG. 4C illustrates an example of a verification screen 420.

When the user raises a hand or makes a predetermined gesture to the image capture apparatus 102 in the meeting room, a verification process is passed.

After the verification process is passed, the second meeting control apparatus 307 starts feeding a video captured by the image capture apparatus 102 in Room B. The second meeting control apparatus 307 accesses to the server 301 and joins the online meeting with “Meeting ID”.

FIG. 4D illustrates an example of a meeting screen 430 after the multi online meeting has started. The client 305 shows the meeting screen 430 on the display. Not only the video in Room A but also the video in Room B is shown on the meeting screen 430.

In the above flow, the second meeting control apparatus 307 verifies if someone is in the meeting room by a human gesture. However, it is not limited to this. FIG. 4E illustrates another example of a verification screen 440. In this verification method, the user is required to enter a verification code on the verification screen 440. FIG. 4F illustrates a screen 450 which is shown on a display connected to the second meeting control apparatus 307 and located in the meeting room. If the user is in the meeting room, the user can see the verification code on the screen 450 and can enter the code in the verification screen 440. By entering the code in the verification screen 440, the verification process is passed.

In the above flow, “Meeting ID” is sent to the second meeting control apparatus 307 from the client 305. The client 305 and the second meeting control apparatus 307 are in the same network (LAN). The second meeting control apparatus 307 accepts “Meeting ID” and a request to join the online meeting only from devices in the same network. This is to ensure security and confidentiality in the meeting room. However, it is not limited to this. “Meeting ID” and the request to join the online meeting may be sent to the second meeting control apparatus 307 from the server 301. The user may select an option that the second meeting control apparatus 307 accepts “Meeting ID” and the request to join the online meeting not only from the devices in the same network but also devices in different network.

In accordance with the above description the following embodiments are derived. In one embodiment, A system and method for setting multi room online meeting is provided and includes a client, a server, a first meeting control apparatus associated with a first room, and a second meeting control apparatus associated with a second room. The client is configured to request to the server to add another meeting control apparatus to the online meeting which the first meeting control apparatus joins, the server is configured to provide access information to the second meeting control apparatus to the client in response to the request from the client, the client is configured to access to the second meeting control apparatus based on the access information provided by the server and send the meeting ID to the second meeting control apparatus so that the second meeting control apparatus can join the online meeting such that the second meeting control apparatus performs a verification process to check if a person is in the second room or not, and joins the online meeting and send an image captured by an image capture apparatus in the second room to the server after the verification process is passed.

In one embodiment, verification process includes showing, at the client, a verification screen on a display of the client to notify the person to make a predetermined gesture and the second meeting control apparatus is configured to obtain the image captured by the image capture apparatus and determine if the person makes the predetermined gesture based on the image, and the verification process is passed in a case where the second meeting control apparatus determines the person makes the predetermined gesture.

In another embodiment, the verification process includes the second meeting control apparatus showing a screen on a display located in the selected room, the screen showing a verification code and the client is configured to show a verification screen on a display of the client to notify the person to enter the verification code into the verification screen, and sends an entered code to the second meeting control apparatus, and the verification process is passed in a case where the entered code matches the verification code.

In a further embodiment, the server is configured to provide the client, after the second meeting control apparatus joins the online meeting, with an image captured by an image capture apparatus in the first room and the image captured by the image capture apparatus in the second room.

In another embodiment, an apparatus and method are provided. The apparatus includes at least one memory storing instructions; and at least one processor that, upon execution of the instructions stored in at least the one memory, is configured to receive a meeting ID for an online meeting which another apparatus joins, perform a verification process to check if a person is in a room or not, join the online meeting with the meeting ID and send an image captured by an image capture apparatus in the room to the server after the verification process is passed.

In another embodiment, the apparatus and method includes obtaining the image captured by the image capture apparatus and determine if the person makes a predetermined gesture based on the image, and the verification process is passed in a case where the apparatus determines the person makes the predetermined gesture.

In a further embodiment, the apparatus and method show a screen on a display located in the room, the screen showing a verification code, receive a code entered by a user from a client, and wherein the verification process is passed in a case where the entered code matches the verification code.

It should be understood that any of the above described configurations and embodiments, may be combined in any manner and the scope of the invention according to the present disclosure contemplates the various different embodiments.

While different exemplary embodiments have been described, respective features of each of these exemplary embodiments can be combined in accordance with the principles of the disclosure therein. As such, the above descriptions are intended to clearly describe the principles of each exemplary embodiment and skilled artisans would be able to combine respective features of one or more of the exemplary embodiments and combine them with features of any of the other exemplary embodiments.

The scope of the present disclosure includes a non-transitory computer-readable medium storing instructions that, when executed by one or more processors, cause the one or more processors to perform one or more exemplary embodiments of the present disclosure. Examples of a computer-readable medium include, but are not limited to, a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can be supplied to the computer-readable storage medium via download via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

The present disclosure can be incorporated in the form of a variety of embodiments, only a few of which are disclosed herein. Variations of those embodiments may become apparent to those of ordinary skill in the art upon reading the foregoing description. Accordingly, this disclosure and any embodiments derived therefrom includes all modifications and equivalents of the subject matter recited in the claims appended hereto as permitted by applicable law. Any combination of the above-described elements in all possible variations thereof is encompassed by the disclosure unless otherwise indicated herein or otherwise clearly contradicted by context.

We claim:

1. A system for setting multi online meeting, the system comprising a client, a server, a first meeting control apparatus associated with a first room, and a second meeting control apparatus associated with a second room, wherein,
the client is configured to request to the server to add another meeting control apparatus to the online meeting which the first meeting control apparatus joins,
the server is configured to provide access information to the second meeting control apparatus to the client in response to the request from the client,
the client is configured to access to the second meeting control apparatus based on the access information provided by the server,
the client is configured to send the meeting ID to the second meeting control apparatus so that the second meeting control apparatus can join the online meeting,
the second meeting control apparatus is configured to perform a verification process to check if a person is in the second room or not, and
the second meeting control apparatus is configured to join the online meeting and send an image captured by an image capture apparatus in the second room to the server after the verification process is passed.

2. The system according to claim 1, wherein the verification process includes:
the client is configured to show a verification screen on a display of the client to notify the person to make a predetermined gesture,
the second meeting control apparatus is configured to obtain the image captured by the image capture apparatus and determine if the person makes the predetermined gesture based on the image, and
wherein the verification process is passed in a case where the second meeting control apparatus determines the person makes the predetermined gesture.

3. The system according to claim 1, wherein the verification process includes:
the second meeting control apparatus is configured to show a screen on a display located in the selected room, the screen showing a verification code,
the client is configured to show a verification screen on a display of the client to notify the person to enter the verification code into the verification screen, and
the client is configured to send an entered code to the second meeting control apparatus, and
wherein the verification process is passed in a case where the entered code matches the verification code.

4. The system according to claim 1, wherein,
the server is configured to provide the client, after the second meeting control apparatus joins the online meeting, with an image captured by an image capture apparatus in the first room and the image captured by the image capture apparatus in the second room.

5. A method for setting multi online meeting with a client, a server, a first meeting control apparatus associated with a first room, and a second meeting control apparatus associated with a second room, the method comprising:
requesting to the server to add another meeting control apparatus to the online meeting which the first meeting control apparatus joins;
providing access information to the second meeting control apparatus to the client in response to the request from the client;
accessing to the second meeting control apparatus based on the access information provided by the server;
sending the meeting ID to the second meeting control apparatus so that the second meeting control apparatus can join the online meeting;
performing a verification process to check if a person is in the second room or not, and
joining the online meeting and sending an image captured by an image capture apparatus in the second room to the server after the verification process is passed.

6. The method according to claim 5, wherein the verification process includes:
showing a verification screen on a display of the client to notify the person to make a predetermined gesture,
obtaining the image captured by the image capture apparatus and determine if the person makes the predetermined gesture based on the image, and
wherein the verification process is passed in a case where the second meeting control apparatus determines the person makes the predetermined gesture.

7. The method according to claim 5, wherein the verification process includes:
showing a screen on a display located in the selected room, the screen showing a verification code,
showing a verification screen on a display of the client to notify the person to enter the verification code into the verification screen, and
sending an entered code to the second meeting control apparatus, and
wherein the verification process is passed in a case where the entered code matches the verification code.

8. The method according to claim 5, wherein,
providing the client, after the second meeting control apparatus joins the online meeting, with an image captured by an image capture apparatus in the first room and the image captured by the image capture apparatus in the second room.

9. An apparatus comprising:
at least one memory storing instructions; and
at least one processor that, upon execution of the instructions stored in at least the one memory, is configured to: receive a meeting ID for an online meeting which another apparatus joins;
perform a verification process to check if a person is in a room or not;
join the online meeting with the meeting ID and send an image captured by an image capture apparatus in the room to the server after the verification process is passed.

10. The apparatus according to claim 9, wherein at least the one processor is further configured to:
obtain the image captured by the image capture apparatus and determine if the person makes a predetermined gesture based on the image, and
wherein the verification process is passed in a case where the apparatus determines the person makes the predetermined gesture.

11. The apparatus according to claim 9, wherein at least the one processor is further configured to:
show a screen on a display located in the room, the screen showing a verification code,
receive a code entered by a user from a client, and
wherein the verification process is passed in a case where the entered code matches the verification code.
